(19) United States
(12) Patent Application Publication
(10) Pub. No.: US 2007/0222249 A1
(43) Pub. Date: Sep. 27, 2007

(54) Interior trim panel with integrated living hinged components

(76) Inventors: Jeffrey Valentage, Royal Oak, MI (US); Joseph Gustaaf Marie Flendrig, Brussels (BE)

Correspondence Address: ExxonMobil Chemical Company;Law Technology, P.O. Box 2149, Baytown, TX, 77522-2149, US

(21) Appl. No.: 11/704,047

(22) Filed: Feb. 8, 2007

Related U.S. Application Data
(63) Continuation-in-part of application No. 11/590,307, filed on Oct. 31, 2006.
(60) Provisional application No. 60/785,044, filed on Mar. 23, 2006.

(51) Int. Cl. B60R 13/01

(52) U.S. Cl. 296/39.1

(57) ABSTRACT

This invention relates to an integrated trim panel system, comprising:
a trim module;
at least one component attached to the trim module via a living hinge,
wherein the trim module and the living hinge are injection molded together, and the at least one component is adapted to be folded about the living hinge and attached to the trim module without separating the at least one component from the trim module.

### CROSS REFERENCE TO RELATED APPLICATIONS

This application claims the benefit of and priority from U.S. Ser. No. 60/785,044, filed Mar. 23, 2006. This application is also a continuation-in-part of 11/590,307, filed Oct. 31, 2006. All of the above applications are fully incorporated herein by reference.

### BACKGROUND OF THE INVENTION

1. Field of the Invention

This invention relates to door systems. More particularly, embodiments of the present invention relate to door systems for vehicles, such as automobiles, specifically cars and

2. Description of the Related Art

Conventional doors for automobiles typically include a frame, exterior skin panel, and interior trim panel. Depending on the type of vehicle and option package, automotive doors can have more than fifty to greater than one hundred individual components. Such components can include various hardware, electrical parts, and sealing members. Illustrative hardware components can include window regulators, window tracks, windows, door locks, and impact bolsters. Certain electrical components can include wire harnesses, speakers, window motors, and outside mirror motors. Sealing components can include glass run channels, beltlines, lower sashes, plugs, grommets, and core to frame seals. Each of these components is pre-assembled and attached or otherwise hung on one of the main panels or frame, which are then assembled together to form the door which is attached to the vehicle's chassis.

Each component is typically supplied by a different vendor or supplier, some of which are known in the industry as Tier 1, Tier 2, and Tier 3 suppliers. In most cases, an original equipment manufacturer (OEM) produces the frame and exterior skin panel that are stamped separately from cold rolled steel, welded together, and painted to provide a door shell. The numerous individual components provided by the Tier 1, 2, and 3 suppliers are then assembled onto the OEM's door shell, typically at the OEM's assembly line to provide the door.

A number of such components can be made from an injection moldable resin. A majority of the moldable components are injection molded separately and then assembled to the trim panel. The extra assembly of those components adds cost to the finished trim panel due to the assembly equipment, injection molding machines, and injection molding tools needed to make and assemble the separate components. With an average of 3.3 doors per vehicle, assembly costs can be considerable. In addition other incidental and related costs such as ordering, storage, management, transportation, and the floor space to assemble the door components, add to the overall cost of production.

There is a need, therefore, for a door assembly having fewer individual components. There is also a need for a door assembly that minimizes the number of individual components requiring assembly.

### SUMMARY OF THE INVENTION

This invention relates to an integrated trim panel system, comprising:
a) a trim module;
b) at least one component attached to the trim module via a living hinge,
c) wherein the trim module and the living hinge are injection molded together, and the at least one component is adapted to be folded about the living hinge and attached to the trim module without separating the at least one component from the trim module.

### BRIEF DESCRIPTION OF THE DRAWINGS

FIG. 1 is a schematic illustration of one embodiment of a door according to embodiments herein.

FIG. 2 is a schematic illustration of a trim panel having one or more components attached thereto via a living hinge.

FIG. 3 is a schematic, side view of a trim panel having at least one component, such as a speaker box and/or pocket, attached thereto via a living hinge.

FIG. 4 is a simplified schematic of a living hinge.

FIG. 5 is a schematic, side view of an illustrative fastener member.

FIG. 6 is a schematic illustration of the exterior side of an assembled trim panel after the one or more components are attached in place.

FIG. 7 is an enlarged, partial cross section taken along lines A-A of FIG. 6.

FIG. 8 is an enlarged partial cross section taken along lines B-B of FIG. 6.

FIG. 9 is a schematic view of an interior side of an assembled trim panel according to one or more embodiments described.

FIG. 10 is a schematic illustration of another embodiment of a door.

### DETAILED DESCRIPTION OF THE INVENTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

An integrated trim panel having one or more components molded therewith is provided along with a door system that includes the integrated trim panel. The one or more components are molded with the trim panel and are connected thereto via a living hinge. Due to its simplicity and high level of integration, the integrated trim panel reduces the number of individual components (i.e., parts) and assembly steps to produce the finished door. Preferably, the trim panel utilizes multi-material injection molding technology and/or in-mold assembly techniques to integrate the various components. As such, the number of individual components requiring assembly is minimized, thereby reducing assembly time, floor space, and associated costs.

In at least one specific embodiment, an interior trim panel is injection molded with a pocket and/or speaker box attached thereto by a living hinge. Once the part has been molded, the pocket and/or speaker box is simply folded over and snapped in place. Alternatively, the pocket and/or speaker box can be welded or adhered to the trim panel.

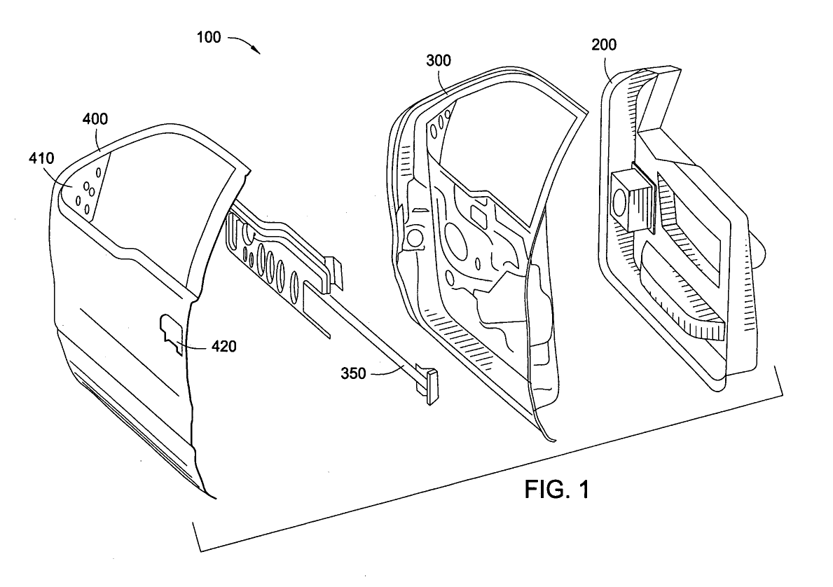

FIG. 1 shows a schematic illustration of one embodiment of a door 100. As shown, the door 100 includes a trim panel 200, inner panel 300, intrusion beam 350, and outer panel 400. Each of the inner panel 300, intrusion beam 350, and outer panel 400 can be stamped from cold, rolled steel. Alternatively, each of those components 300, 350, 400 in addition to the trim panel 200 can be injection molded from one or more polymers such as polyethylene, polypropylene, or one or more other polymer materials, such as those described herein, using conventional injection molding techniques, including multi-material or multi-shot injection molding techniques.

Multi-material or multi-shot injection molding techniques allow multiple materials to be injection molded into a single or multiple cavity mold. Any suitable multi-material injection molding machine can be used, such as an Engel Victory Combi machine available from Engel Corp. Additional processing techniques can be used to enhance and/or facilitate the integration. Illustrative techniques include multiple cavity tools, insert molding, movable core sections, gas/water assist, and robotic extrusion of seals into the injection mold.

The outer panel 400 has an interior side and an exterior side. The exterior side provides the housing for a side mirror (not shown) that is assembled to the outer panel 400 at location 410. The exterior side also provides the housing for a door handle (not shown) that would be assembled at location 420. As used herein, the term “exterior” refers to an orientation or direction facing away from the inside of the vehicle, and the term “interior” refers to an orientation or direction facing toward the inside the vehicle.

As mentioned, the outer panel 400 can be injection molded from one or more polymers such as polyethylene, polypropylene or one or more materials described herein. Preferably, the outer panel 400 is injection molded from a reinforced polypropylene. The outer panel 400 can also be stamped from cold, rolled steel and painted to meet the specifications of the OEM.

The inner panel 300 is assembled to the outer panel 400 and encloses the intrusion beam 350 therebetween. The intrusion beam 350 can be assembled on either the outer panel 400 or the inner panel 300. The inner panel 300 can provide a housing or substrate for one or more electrical, mechanical and sealing components to be attached thereto. Illustrative components include, but are not limited to window regulators, motors, and tracks; switches; door handles; door locks; impact bolsters; arm rests; map pockets; wire harnesses; speaker boxes or receptacles; speakers; window motors; outside mirror motors; beltline seals; plugs; grommets; and core to frame seals.

The trim panel 200 can be assembled on the inner panel 300. Like the inner panel 300, the trim panel 200 can provide a housing or substrate for one or more electrical, mechanical and sealing components to be attached thereto. Illustrative components include, but are not limited to window regulators, motors, and tracks; switches; door handles; door locks; impact bolsters; arm rests; map pockets; wire harnesses; speaker boxes or receptacles; speakers; window motors; outside mirror motors; beltline seals; plugs; grommets; and core to frame seals.

Preferably, the trim panel 200 is produced from polyethylene, polypropylene and/or one or more other polymer materials described herein, using multi-material or multi-shot injection molding techniques. In one embodiment, a less expensive, more durable material can be molded on a first side of the trim module 200, while a material that has an attractive feel and texture can be molded on a second side of the trim panel 400 that communicates with the interior of the automobile.

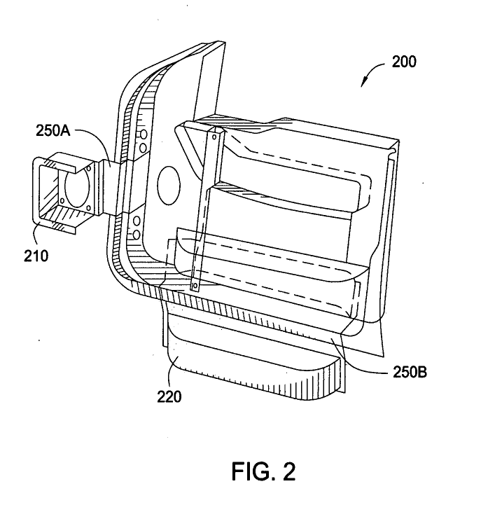

FIG. 2 is a schematic view of an illustrative trim panel 200 according to one or more embodiments described herein. In at least one embodiment, the trim panel 200 includes a speaker box 210 and a pocket 220, such as a map pocket, attached thereto via living hinges 250A, 250B. The term “living hinge” as used herein refers to a thin section of plastic or engineering resin that connects two components or parts to one another and allows those two parts to be opened and closed about the hinge.

Preferably the speaker box 210 and pocket 220 are integrally formed with the trim panel 200 using multi-material or multi-shot injection molding techniques. Each of the trim panel 200, speaker box 210, and pocket 220 can be molded from the same or different material (e.g., polyethylene, polypropylene, impact copolymer, engineering resins, etc.), depending on the desired specifications. Other suitable materials including those described herein can be used.

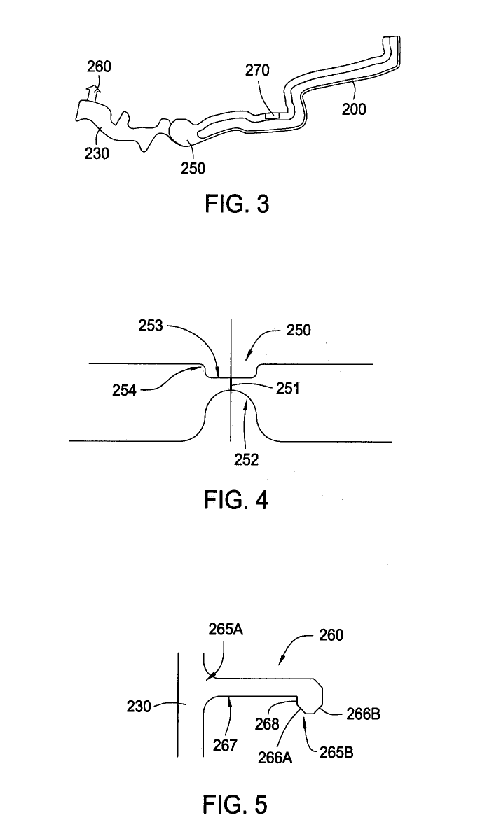

FIG. 3 shows a schematic, side view of a trim panel 200 having at least one component 230, such as a speaker box and/or map pocket, attached thereto via the living hinge 250. The component 230 includes at least one fastener member 260 for securing the component 230 to the trim panel 200. The trim panel 200 preferably includes a receptacle or mating recess 270 to receive the fastener member 260. Although only one fastener 260 is shown, the component 230 can have any numbers of fasteners 260 disposed thereon. The number of fasteners 260 can depend on the size of the component 230 and the thickness and/or stiffness of the living hinge 250, trim panel 200, or both.

FIG. 4 shows a simplified schematic of an illustrative living hinge 250. Typically, the living hinge 250 has a thickness 251, a radius below 252, and a recessed flat section 253 above. The thickness 251 should be sufficient to provide a restriction to melt flow that orients the molecules of the molded material across the hinge 250. Preferably, the thickness 251 can range from a low of about 0.01 inches, 0.05 inches or 0.10 inches to a high of about 0.15 inches, 0.25 inches, or 0.30 inches.

The recessed flat section 253 above the hinge 250 allows the two parts (e.g., 200, 230) to fit together accurately while providing an open space for the hinge 250 to deform. The flat section 253 above the hinge 250 can be at least 0.030 inches in length, and the depth 254 can be at least 0.005 inches to avoid a sharp bend of the hinge 250. In one or more embodiments, the flat section 253 can be at least 0.040 inches in length, at least 0.050 inches in length, at least 0.060 inches in length, at least 0.070 inches in length, or at least 0.080 inches in length. In one or more embodiments, the flat section 253 can be at least 0.002 inches in depth, at least 0.003 inches in depth, at least 0.004 inches in depth, at least 0.005 inches in depth, at least 0.006 inches in depth, or at least 0.007 inches in depth.

Forcing the melt to flow through the hinge 250 requires high injection pressure and speed. Therefore, molds should be built strong enough to withstand these pressures. Flexing of the mold plates by about 0.001 to 0.10 inches, more preferably 0.001 to 0.002 inches, can help the performance of the hinge 250. Furthermore, the shear developed as the melt flows through the hinge 250 generates heat. A hinge mold that provides for adequate cooling at the hinge 250 is desirable. Rapid cooling also reduces crystallinity in the hinge 250 and produces a longer-lasting living hinge 250.

During injection molding, gates are preferably located on both sides of the hinge 250. The injection gates are preferably positioned to avoid a weldline in the hinge 250. In order to encourage molecular orientation, the gate is preferably located to provide for the melt to flow across the hinge in a direction perpendicular to its length. Best results can be achieved if the melt reaches the hinge 250 along its entire length at the same instant. If melt reaches the hinge 250 in some locations before others, the melt stops flowing and starts to cool. This condition results in molded-in stress and weld lines in the hinge 250. Moldfilling analyses can help indicate the best gate location for molecular orientation, uniform melt flow, and the avoidance of weld lines. Additional molecular orientation and flex life can be achieved by bending the hinge a few times while the material is still hot from molding.

Referring again to FIG. 3, the one or more fastener members 260 can be designed in any configuration or shape that can provide optimal insertion force and disassembly forces (for service purposes). An optimal design will insure that the component 230 maintains its position on the trim panel 200 even under load conditions. If a fastener member 260 that extends from the component 230 is not possible of feasible due to part design restrictions, other ways of attaching the hinged component 230 can be employed, including adhesive bonding and welding (sonic or vibration), for example.

FIG. 5 shows a schematic, side view of an illustrative fastener member 260. In at least one embodiment, the fastener member 260 is a snap type connector as shown. The fastener member 260 has a first end 265A connected or otherwise disposed on the component 230, and a second end or head 265B extending from the component 230. The fastener 260 also includes a recessed section 267 disposed between the head 265B and the first end 265A. A shoulder 268 is defined by the recessed portion 267 and the head 265B. The head 265B can include one or more sloped surfaces (two are shown 266A and 266B) to ease friction upon contact with the receptacle 270 of the trim panel 200 (shown in FIG. 3).

The recessed section 267 preferably has a thickness such that the fastener 260 can flex or bend as needed to make a connection with the receptacle 270 of the trim panel 200. In one or more embodiments, the thickness of the recessed section 267 is between 40% and 60%, preferably between 45% and 55%, of the wall thickness of the component 230 in which the fastener 265 is attached.

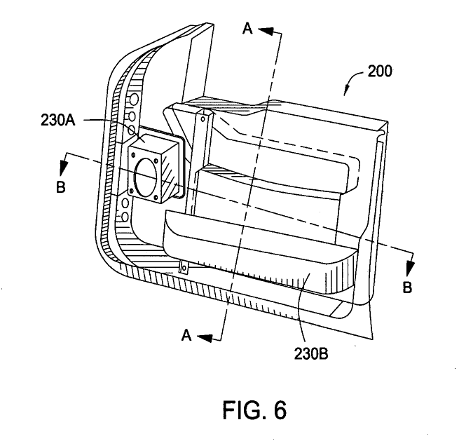

FIG. 6 is a schematic illustration of an assembled trim panel 200 after the one or more components (two are shown 230A, 230B) are attached in place. In the embodiment shown, the component 230A represents a speaker box, and the component 230B represents a map pocket.

Once the trim panel 200 and the one or more components 230A and 230B have been molded, each component 230A, 230B can be folded over its respective living hinge (e.g., 250A or 250B as shown in FIG. 2). The components 230A, 230B can then be snapped into the body of the trim panel 200 via the one or more fastener members 260 and receptacles 270, as shown in FIG. 3.

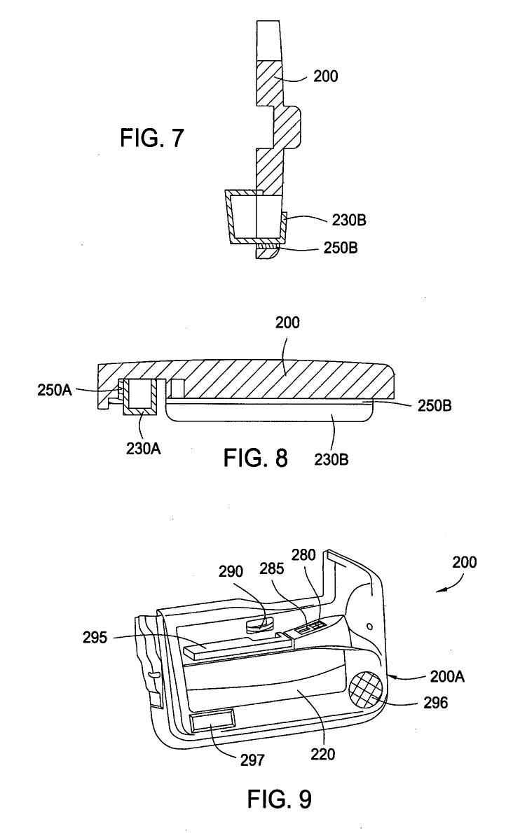

For another perspective, FIGS. 7 and 8 show partial cross sectional views of the body of the trim panel 200. More particularly, FIG. 7 is an enlarged partial cross section taken along lines A-A of FIG. 6, and FIG. 8 is an enlarged partial cross section taken along lines B-B of FIG. 6. As shown in FIG. 7, the component 230B is folded over hinge 250B and secured in place to the trim panel 200. Similarly, the component 230A is folded over hinge 250A and secured in place to the trim panel 200. Although the hinge 250B is shown as one, continuous piece in FIG. 8 each of the hinges 250A, B can be two or more discontinuous sections.

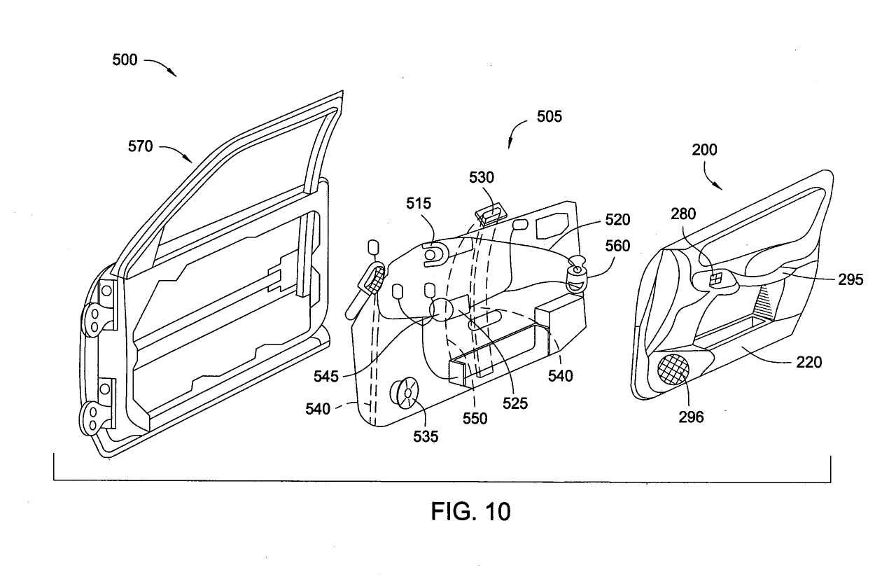

FIG. 9 shows a schematic view of the interior side 200A of the trim panel 200 after assembly. For simplicity and ease of description, the interior side 200A of the trim panel 200 is shown having one or more window switches 280, door lock switches 285, door handle 290, arm rest 295, speaker cover 296, lights 297, and map pocket 220. It is to be understood, however, that the interior side 200A of the trim panel 200 can have any feature and option depending on the make and model of the car, including for example, side mirror heater vents, side mirror controls, additional speakers, etc. Further, it should be readily understood that the assembled speaker box 210 cannot be shown in this view.

FIG. 10 shows a schematic illustration of another embodiment of a door assembly 500. In this embodiment, the integrated trim panel 200 can be used with a pre-assemble core module 505. The various hardware, electrical and sealing components mentioned can be assembled to the core module 505, including an interior door handle 515, handle linking cables 520, motor 525, window regulator 530, speaker cover 535, window guide rails 540, drum pulley 545, cable 550, and door latch unit 560. After these functional parts and devices are attached to the core module 505, the core module 505 is attached to a door panel sub-assembly or outer panel 570. The integrated interior trim panel 110 is then attached to the outer panel 570.

Other embodiments also will allow the integration of other components such as speakers, wiring harness, switches, and other hardware and electrical components onto the backside of the trim panel 200. An armrest (with or without skin/foam covering) could also be made an integral part of the map pocket and or speaker box. Furthermore, two component molding could be used to mold the skin/foam onto the armrest. Also, gas or water assist could be used to create one or more hollow sections in the armrest if desired to add strength or stiffness.

In one or more embodiments above or elsewhere herein, the backside of the map pocket and/or speaker box could serve as the attachment point of the trim panel to the door assembly utilizing additional attachment features that would be non-visible to the consumer. This would improve the aesthetics of the trim panel by eliminating unsightly attachment features such as screws or clips.

As noted above, the degree of integration described will dramatically reduce the cost and complexity of the finished door. Injection molding techniques described can significantly reduce assembly errors in addition to the overall cost. The multi-material injection molding techniques described can also provide a unique combination of materials. Further, the number of secondary attachment techniques needed for multiple components such as rivets, screws, adhesives, clips, snaps, etc., is greatly reduced, if not eliminated all together in some instances.

### Materials

The components described, including the trim panel 200, inner panel 300, intrusion beam 350, and outer panel 400, can be made from any material having the requisite properties, such as stiffness and strength for example. Suitable materials include, but are not limited to, propylene homopolymers, propylene copolymers, ethylene homopolymers, ethylene copolymers, and or any one or more of the following polymer resins:
a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon 6/66/610 (N6/66/610), nylon MXD6 (MXD6), nylon 6T (N6T), nylon 6/6T copolymer, nylon 66/PP copolymer, nylon 66/PPS copolymer;
b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters;
c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS);
d) polymethacrylate resins such as polymethyl methacrylate and polyethylacrylate;
e) cellulose resins such as cellulose acetate and cellulose acetate butyrate;
f) fluorine resins such as polyvinylidene fluoride (PVDF), polyvinyl fluoride (PVF), polychlorofluoroethylene (PCTFE), and tetrafluoroethylene/ethylene copolymer (ETFE);
g) polyimide resins such as aromatic polyimides;
h) polysulfones;
i) polyacetals;
j) polyactones;
k) polyphenylene oxides and polyphenylene sulfides;
l) styrene-maleic anhydrides;
m) aromatic polyketones,
n) polycarbonates (PC);
o) elastomers such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like); and
p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, sand, glass beads, mineral aggregates, talc, and hydrotalcite compounds of the ions Mg, Ca, or Zn with Al, Cr, or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g., Kevlar or Twaron), meta-aramide fibers (e.g., Nomex), polyethylene fibers (e.g., Dyneema), and combinations thereof.

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Most preferred is a PP reinforced with a PET fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D-4703 Method B or ASTM D-1505, and a melt index (MI) between 0.10 dg/min and 30 dg/min according to ASTM D-1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D-1238. Preferred plastomers can have an average molecular weight of from 10,000 to 800,000 in one embodiment, and from 20,000 to 700,000 in another embodiment. The molecular weight distribution (Mw/Mn) of desirable plastomers ranges from 1.5 to 5 in one embodiment, and from 2.0 to 4 in another embodiment. The 1% secant flexural modulus (ASTM D-790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. Preferably, the copolymer has a density less than 0.915 g/cm³. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MPa. Further, preferred blends will have a flexural modulus of 1,750 MPa or more, such as about 1,800 MPa or more, or more than about 2,000 MPa.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

In another embodiment, this invention relates to:
1. An integrated trim panel system, comprising:
   a trim module;
   at least one component attached to the trim module via a living hinge,
   wherein the trim module and the living hinge are injection molded together, and the at least one component is adapted to be folded about the living hinge and attached to the trim module without separating the at least one component from the trim module.
2. The trim panel system of paragraph 1, wherein each component comprises one or more fasteners adapted to attach the component to the trim module.
3. The trim panel system of paragraph 1 or 2, wherein the at least one fastener is a snap member.
4. The trim panel system of paragraph 1, 2, or 3, wherein the at least one fastener is shaped like a cone.
5. The trim panel system of any of paragraphs 1 to 4, wherein the trim module includes at least one receptacle to engage the fastener of the component.
6. The trim panel system of any of paragraphs 1 to 5, wherein the at least one component is a speaker box.
7. The trim panel system of any of paragraphs 1 to 6, wherein the at least one component is a pocket.
8. The trim panel system of any of paragraphs 1 to 7, wherein the at least one component is a map pocket.
9. The trim panel system of any of paragraphs 1 to 8, wherein the at least one component is an arm rest.
10. The trim panel system of any of paragraphs 1 to 9, wherein the at least one component comprises a pocket and a speaker box.
11. The trim panel system of any of paragraphs 1 to 10, wherein the at least one component comprises a pocket and a speaker box, the pocket and the speak box having a living hinge therebetween.
12. An integrated door system, comprising:
   a trim module;
   at least one component attached to the trim module via a living hinge,
   wherein the trim module and the living hinge are injection molded together, and the at least one component is adapted to be folded about the living hinge and attached to the trim module without separating the at least one component from the trim module; and an outer panel.

The integrated door system of paragraph 12, further comprising an inner panel adapted to be attached to the outer panel and the trim module.

The integrated door system of paragraph 12 or 13, further comprising the core module comprises one or more components attached thereto, the one or more components selected from the group consisting of a speaker box, armrest, map pocket, and air channel.

The integrated door system of any of claims 12 to 14, wherein the trim module comprises one or more integrated sealing systems injection molded therewith, and one or more integrated window tracks injected molded therewith.

The integrated door system of any of claims 12 to 15, wherein the trim module is directly coupled to the outer panel.

The integrated door system of any of claims 12 to 17, wherein each component comprises one or more fasteners adapted to attach the component to the trim module.

The integrated door system of paragraph 17, wherein the at least one fastener is a snap member.

The integrated door system of paragraph 17, wherein the at least one fastener is shaped like a cone.

The integrated door system of paragraph 17, wherein the trim module includes at least one receptacle to engage the fastener of the component.

The integrated door system of any of paragraph 12 to 20, further comprising a core module adapted to be attached to the outer panel on a first side thereof and the trim module on a second side thereof.

The integrated door system of paragraph 21, wherein the core module is injection molded.

The integrated door system of any of paragraphs 13 to 22, wherein the inner panel is formed from stamped steel.

One of ordinary skill in the art will recognize that the door system described can be utilized as a complete system, or the individual components thereof can be utilized separately as individual mini-systems or modular type units to help consolidate two or more components if desired.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents, including priority documents, cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. An integrated trim panel system, comprising:
a trim module;
at least one component attached to the trim module via a living hinge,
wherein the trim module and the living hinge are injection molded together, and the at least one component is adapted to be folded about the living hinge and attached to the trim module without separating the at least one component from the trim module.

2. The trim panel system of claim 1, wherein each component comprises one or more fasteners adapted to attach the component to the trim module.

3. The trim panel system of claim 1, wherein the at least one fastener is a snap member.

4. The trim panel system of claim 1, wherein the at least one fastener is shaped like a cone.

5. The trim panel system of claim 1, wherein the trim module includes at least one receptacle to engage the fastener of the component.

6. The trim panel system of claim 1, wherein the at least one component is a speaker box.

7. The trim panel system of claim 1, wherein the at least one component is a pocket.

8. The trim panel system of claim 1, wherein the at least one component is a map pocket.

9. The trim panel system of claim 1, wherein the at least one component is an arm rest.

10. The trim panel system of claim 1, wherein the at least one component comprises a pocket and a speaker box.

11. The trim panel system of claim 1, wherein the at least one component comprises a pocket and a speaker box.

12. An integrated door system, comprising:
a trim module;
at least one component attached to the trim module via a living hinge, wherein the trim module and the living hinge are injection molded together, and the at least one component is adapted to be folded about the living hinge and attached to the trim module without separating the at least one component from the trim module; and
an outer panel.

13. The integrated door system of claim 12, further comprising an inner panel adapted to be attached to the outer panel and the trim module.

14. The integrated door system of claim 12, the one or more components selected from the group consisting of a speaker box, armrest, map pocket, and air channel.

15. The integrated door system of claim 12, wherein the trim module comprises one or more integrated sealing systems injection molded therewith and one or more integrated window tracks injected molded therewith.

16. The integrated door system of claim 12, wherein the trim module is directly coupled to the outer panel.

17. The integrated door system of claim 12, wherein each component comprises one or more fasteners adapted to attach the component to the trim module.

18. The integrated door system of claim 17, wherein the at least one fastener is a snap member.

19. The integrated door system of claim 17, wherein the at least one fastener is shaped like a cone.

20. The integrated door system of claim 17, wherein the trim module includes at least one receptacle to engage the fastener of the component.

21. The integrated door system of claim 12, further comprising a core module adapted to be attached to the outer panel on a first side thereof and the trim module on a second side thereof.

22. The integrated door system of claim 21, wherein the core module is injection molded.

23. The integrated door system of claim 13, wherein the inner panel is formed from stamped steel.
